(19) United States
(12) Patent Application Publication
(10) Pub. No.: US 2016/0039648 A1
(43) Pub. Date: Feb. 11, 2016

(54) A LIFT TRUCK EQUIPPED WITH STABILIZER MEANS

(71) Applicant: C.M.C. S.R.L. - SOCIETA UNIPERSONALE, Castelfranco Emilia (Modena) (IT)

(72) Inventor: Riccardo MAGNI, Modena (IT)

(73) Assignee: C.M.C. S.R.L. - Societa Unipersonale, Castelfranco Emilia, Modena (IT)

(21) Appl. No.: 14/782,574

(22) PCT Filed: Apr. 1, 2014
(86) PCT No.: PCT/IB2014/000457

§ 371 Date: Oct. 5, 2015

(30) Foreign Application Priority Data
Apr. 5, 2013 (IT) MO2013A000087

(51) Int. Cl. B66F 9/075; B66F 9/065

(52) U.S. Cl. CPC B66F 9/07559; B66F 9/0655

(57) ABSTRACT

A lift truck comprises a chassis (1) movable on wheels (2) and a rotating platform (3) which supports an operating arm (4); stabilizing means are provided for resting on the ground and positioned at the front as well as at the back. The stabilizing means consist of two pairs of two telescopically extensible arms (5), each one comprising a first segment (6) and a second segment (7). The arms (5) have their ends hinged to opposite sides of the chassis (1), so as to swivel about parallel axes, and have the opposite free ends intended to lean against the ground by means of plates or stabilizing feet (8). The two arms (5) of each pair are arranged side by side at a short distance from each other on parallel planes and are individually bound to the chassis (1) by means of hydraulic cylinders (11). Control means are provided to control at least the return movements of each pair of arms (5) to a folded, contracted configuration, according to a predetermined sequence which provides that, for each single arm (5), full retraction of a respective second segment (7), at least for a predetermined portion of the final part of its return stroke, is carried out only after that the first segment (6) of the other arm (5), belonging to the same said pair of arms (5), has reached a final folding position.

The present invention relates to a lift truck equipped with stabilizing means for resting on the ground.

More precisely, the invention finds its preferred, but not exclusive, collocation in the field of lift trucks equipped with an operating arm, which consists of a telescopic arm rotating about a vertical axis and mounted on a rotating platform. The platform is arranged on a wheeled mobile chassis.

Lift trucks are known of this type. They are equipped with stabilizer means having the function of ensuring an adequate and secure support on the ground during the working phase, i.e. when rotating operating arm is in operation. These means can then be moved to a working position, in which support the whole machine, and a collapsed inactive position, in which they are folded, so as keep the whole machine within the encumbrance configuration permitted by the regulation for the drive on the road.

These stabilizer means often include extensible or foldable outriggers provided with stabilizing plates or feet,

which, in the operation configuration, rest on the ground in order to outline a support polygon, the extent and shape of which essentially determine the ability of the machine to operate safely. The greater the support polygon, the greater the operational capacity of the machine that has its anti tipping characteristics increased. The more regular the perimeter of such a support polygon, the more “uniform” is the practicality of the machine in relation to the possibility of using the operating arm with any orientation with respect to a vertical axis.

Outriggers are known, commonly referred to as “scissor outriggers”, which are arranged at the front as well as at the back on a wheeled chassis of a lift truck equipped with a swiveling operating arm; each “scissors outrigger” include a pair of telescopically extensible arms which have respective ends, opposite to those intended to rest on the ground by means of stabilizer plates or feet, respectively hinged in positions situated near opposite sides of the chassis, so as to swivel about parallel axes. The two arms of each pair are arranged side by side at short distance from each other, operate in planes parallel to each other and are individually bound to the chassis by means of hydraulic cylinders which have their closed sides of their first sections hinged to the chassis and have stabilizer plates or feet hinged to the ends of their second segments or stems. These telescopically extensible arms have only a single extension and have remarkable characteristics of simplicity and robustness. In the totally retracted position, they normally take a horizontal, or nearly horizontal position. In this configuration, the arms, including the stabilizer plate or feet which are freely pivoted at their ends, must not jut out from the transversal outline allowed for the truck.

In known applications of this type, the passage from the collapsed or rest position, to the operation position with the arms extended and resting on the ground, as well as the return motion from the operation position to the rest position, are carried out through operation of the same actuators, which consist of hydraulic cylinders linking the telescopically extensible arms to the chassis, and by similar actuators that control extension and return of the outriggers. While collapsing, that is during the return stroke from the extended position to the collapsed rest one, in order to avoid possible interferences between the plate hinged to the end of the second segment of an outrigger and the end of the other arm, hinged to the chassis, the plate must be situated ad a considerable distance from the outline allowed for the truck.

This geometric condition causes a limitation of the length of the first segment of the outrigger, and therefore a limitation tout court of the arm itself and, consequently, of the support polygon on the ground.

The present invention as is described and claimed in the following, has the main object to overcome such a limitation.

An advantage of the invention consists in the construction and functional simplicity.

Further features and advantages of the present invention will better appear from the detailed description of a preferred embodiment shown, by way of not limited example, in the accompanying figures, in which:

FIG. 1 shows a front view of a lift truck in which the stabilizer means according to the invention are played up in the maximum extension operation configuration;

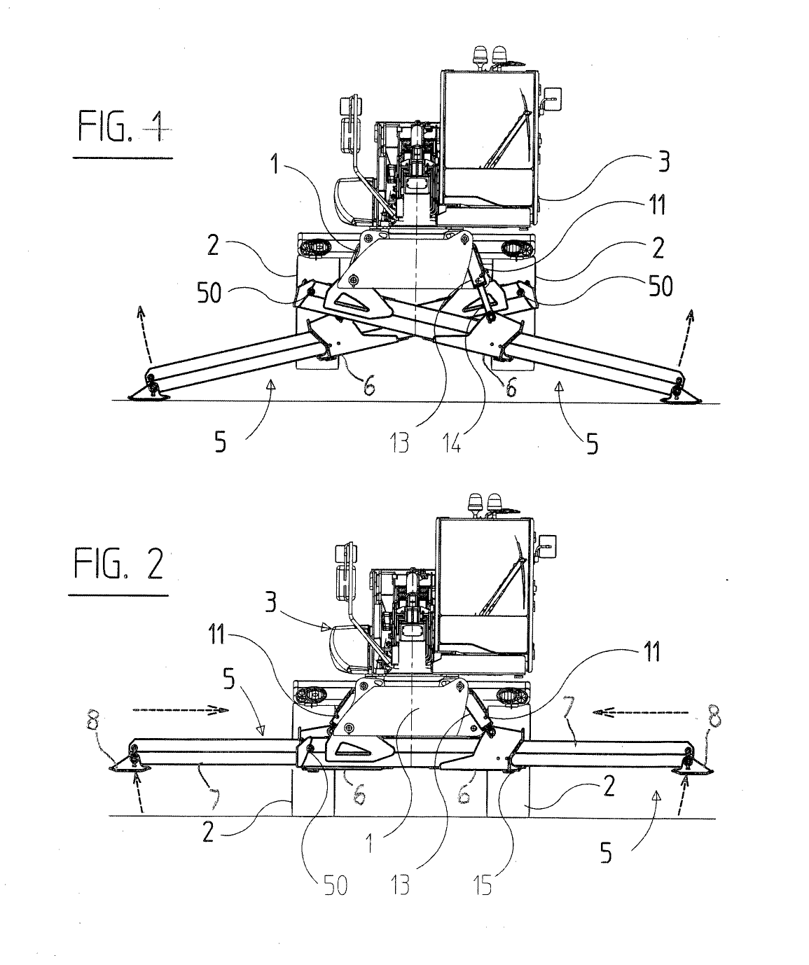

FIG. 2 shows the same view as FIG. 1 with the stabilizer means at an intermediate stage during the return stroke towards the rest position;

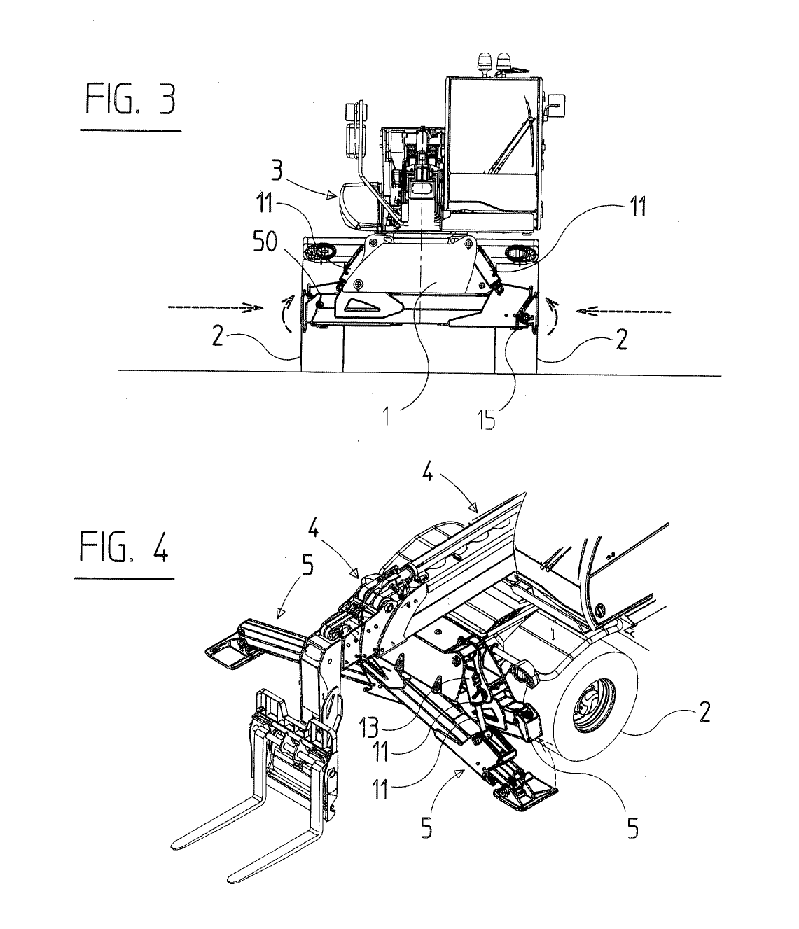

FIG. 3 shows the same view as FIG. 1 with the stabilizer means in a completely collapsed or closed position;

FIG. 4 shows part of a schematic perspective view of the stabilizing means at an intermediate folding stage which is not allowed, because it causes an interference situation.

In the accompanying figures there is shown a lift truck equipped with stabilizing means designed for resting on the ground.

In particular, the lift truck comprises a chassis 1 movable on wheels 2 and a rotating platform 3 which supports an operating arm 4.

The chassis 1 is provided, at the front as well as at the back, with stabilizer means consisting of two pairs of two telescopically extensible arms or outriggers 5, which have respective ends, opposite to those intended to rest on the ground by means of stabilizer plates or feet 8, hinged in positions situated near opposite sides of the chassis 1, so as to swivel about parallel axes by means of pivots 50. These axes are parallel to the longitudinal axis of the truck. In this way, the two arms 5 of each pair move in planes parallel to each other. Moreover, the two arms are arranged side by side at a short distance from each other, so that they do not interfere with each other. Each arm 5 is of the type with only a single extension because it includes a first segment 6, by which the arm is pivoted to the chassis 1, and a second segment 7 which can be extracted from the first segment, provided with stabilizing plates or feet 8 simply hinged at its free end.

Both the first segment 6 and the second segment 7 consist of strong beams which form a telescopic assembly.

The arms 5 are also individually bound to the chassis 1 by means of hydraulic cylinders 11 which have their closed sides of their first sections 13 hinged to the chassis 1, and have the ends of their stems 14, which can be extracted from the respective first sections 13, hinged to the first sections 6 of the corresponding arms 5.

The arms 5 are preferably bound to the chassis 1 with a symmetrical arrangement with respect to a median plane of the truck which contains its longitudinal axis.

The stabilizing plates or feet 8 are pivoted to the second sections 7 of the arms 5, on pivots that have axes parallel to the pivots 50.

A hydraulic actuator is mounted between the first segment 6 and the second segment 7 and works coaxially to produce extension and retraction. The activation of the arms 5 as well as that of the hydraulic cylinders 11 are therefore implemented hydraulically.

Control means are provided to control at least the return movements of each pair of arms 5 to a folded, collapsed configuration, according to a predetermined sequence which provides that, for each single arm 5, full retraction of the respective stem 7, at least for a predetermined portion of the final part of its return stroke, is carried out only after that the first segment 6 of the other arm 5, belonging to the same said pair of arms 5, has reached or almost reached the final folding position.

This predetermined portion of the final part of the return stroke of the single stem 7 is determined as a function of the geometric and dimensional characteristics of the various elements, n order to avoid possible interferences between the plate 8, hinged to the end of the second segment of an arm 5 and the end, hinged to the chassis, of the first segment 6 of the other arm 5, set therebeside to form the pair of telescopically extensible arms 5. In particular, said predetermined portion of the final part of the return stroke of the single stem 7 is actually determined so that the distance between the plate or foot 8 of the stem 7 of the single arm 5 and the end of the first segment 6 of the other arm 5 of the same pair of arms 5 is positive or at least is not negative, that is, such as to not generate interference between said plate or foot 8 and said first segment 6, in each intermediate configuration taken by the first segment 6 between the one of maximum extension and the one of minimum extension of the hydraulic cylinders 11.

Determined this factor, which is essentially a factor given by the geometry of the system, it will be sufficient to control the sequence of return movements of each second segment 7 as a function of the return of the stem 14 of the corresponding hydraulic cylinder 11. Such movements in sequence can be programmed and managed by means of a control unit.

In this regard, a sequence can naturally also be provided, that can be defined as simplified, according to which the return phase of the second segment 7, with respect to the relative first segment 6, starts only after that the first segment 6 of the other arm has reached the collapsed position.

The control means designed to control at least the return movements of each pair of arms 5 to the collapsed configuration include a position transducer associated with each arm 5 which informs the control unit about the position of the second segment 7 with respect to the first segment 6.

Tilting of the plate 8 occurs when the arms 5 are completely folded, due to the action exerted by an abutment 15 on the same plate in the very last stage of the return stroke of the second segment 7 in the corresponding first segment 6.

The sequence of return movements, three steps of which are shown in FIGS. 1, 2 e 3, show that the invention permits to place the hinge points of the first sections 6 of the arms 5 very close to the lateral vertical planes which define the encumbrance allowed for the vehicle. This situation, which would not be possible while adopting a sequence of “traditional” movements, like the one shown as example in FIG. 4, allows to use arms 5 with the maximum length, and therefore, with the same conditions, the maximum extension of the support polygon with apparent operational advantages that this entails.

1) A lift truck equipped with stabilizer means for resting on the ground including a chassis (1), movable on wheels (2), on which a rotating platform (3) is mounted and accommodates an operating arm (4); said chassis (1) being provided, at the front as well as at the back, with stabilizer means including two pairs of two telescopically extensible arms (5), which have respective ends, opposite to those intended to rest on the ground, by means of stabilizer plates or feet (8), the arms being respectively hinged in positions situated near opposite sides of the chassis (1), so as to swivel about parallel axes; the two arms (5) of each pair being arranged side by side at short distance from each other and acting in planes parallel to each other; said arms (5) being also individually bound to the chassis (1) by means of hydraulic cylinders (11) which have the closed sides of their first sections (13) hinged to the chassis (1) and have the distal ends of their stems (14) hinged to the first segments (6) of the corresponding arms (5); control means being designed to control at least the return movements of each pair of said telescopically extensible arms (5) to a folded, contracted configuration according to a predetermined sequence which provides that, for each single arm (5), full retraction of a respective second segment (7), telescopically coupled to the first segment (6), is carried out, at least for a predetermined portion of the final part of its return stroke, only after that the first segment (6) of the other arm 5, belonging to the same said pair of arms (5), has reached a final folding position;
characterized in that said predetermined portion of the final part of the return stroke of the single second segment (7) is determined so that the distance between said plate or foot (8) of the second segment (7) of the single arm (5) and the end of the first segment (6) of the other arm (5) of the same pair of arms (5) is not negative, that is, such as to not generate interference between said plate or foot (8) and said first segment (6), in each intermediate configuration taken by the first segment (6) between the one of maximum extension and the one of minimum extension of the hydraulic cylinders (11).

2) A lift truck according to claim 1, characterized in that the telescopically extensible arms (5) of said two pairs of arms (5) have their respective ends, opposite to those intended to rest on the ground by means of stabilizer plates or feet (8), respectively hinged to the chassis (1) in diametrically opposed positions with respect to the vertical median plane which contains the longitudinal axis of the truck.

3) A lift truck according to claim 1, characterized in that the control means designed to control at least the return movements of each pair of said telescopically extensible arms (5) to a folded contracted configuration, according to a predetermined sequence which provides that, for each single arm (5), full retraction of a respective second segment (7), is carried out, at least for a predetermined portion of the final part of its return stroke, only after that the first segment (6) of the other arm (5), belonging to the same said pair of arms (5), has reached a final folding position, include a position transducer associated with each said arm (5) which report to a control unit the position of the second segment (7) relative to the first segment (6).

4) A lift truck according to claim 3, characterized in that said arms (5) have such dimension and are located relative to the chassis (1) so that in the contracted or folded, minimum space configuration they do not protrude from the outline of the overall front dimension of the truck.
